(19) United States
(12) Patent Application Publication
(10) Pub. No.: US 2005/0120633 A1
(43) Pub. Date: Jun. 9, 2005

(54) Glass run for vehicle

(76) Inventors: Tomohiro Takase, Aichi-ken (JP); Hitoshi Omori, Aichi-ken (JP); Masanori Aritake, Aichi-ken (JP); Mitsuo Hamabata, Aichi-ken (JP); Harumi Kogiso, Aichi-ken (JP); Akira Ito, Aichi-ken (JP)

Correspondence Address: POSZ LAW GROUP, PLC, 12040 SOUTH LAKES DRIVE, SUITE 101, RESTON, VA, 20191, US

(21) Appl. No.: 10/994,533

(22) Filed: Nov. 23, 2004

(30) Foreign Application Priority Data
Nov. 26, 2003 (JP) P2003-394944
May 18, 2004 (JP) P2004-147162
May 18, 2004 (JP) P2004-147171

(51) Int. Cl. E06B 7/16

(52) U.S. Cl. 49/441

(57) ABSTRACT

The invention is to provide a vehicle glass run, in which a seal lip prevents displacement or vibration of a door glass, exactly holds the door glass, reduces sliding resistance between the door glass and the seal lip, and prevent generation of abnormal noises. The vehicle-interior seal lip is formed to be longer than a vehicle-exterior seal lip, and has a body of the vehicle-interior seal lip extending from the vehicle-interior side wall, a bent portion thereof being bent toward a bottom wall from the body of the vehicle-interior seal lip, and a front end portion of the same extending from the bent portion with a length contacting the vehicle-interior side wall at the front end portion of the vehicle-interior seal lip, when the door glass contacts the vehicle-interior seal lip. The vehicle-interior side wall is performed with a treatment to reduce the sliding resistance on a face of the vehicle-interior side wall contacted by the vehicle-interior seal lip.

### BACKGROUND OF THE INVENTION

1. Field of the Invention

The present invention relates to a vehicle glass run which is mounted in the inner circumference of a door frame of a vehicle door for guiding a door glass moving up and down as well as sealing the space between the door frame and the door glass.

2. Description of Related Art

As shown in FIG. 1, in the inner circumference of the door frame 2 of the vehicle door 1, the glass run 110 is attached for guiding the door glass 5 moving up and down. The cross sectional structure of an existing glass run is shown in FIG. 2 which is a cross sectional view seeing from A-A line of FIG. 1.

By the way, FIGS. 1 and 2 show a door of a sash-type, and this glass run may be also applied to doors of press type.

Conventionally, the glass run 110 has been, as shown in FIG. 1, attached in a channel 3 of the door frame 2 for guiding the door glass 5 moving up and down as well as sealing the space between the door glass 5 and the door frame 2. The glass run 110 connects a linear extruded part formed by extrusion forming to a part formed by molding in conforming to the shape of a corner part of the door frame 2. The sealing between a door 1 and a vehicle body is made by a door weather strip and/or an opening trim weather strip (not shown), the door weather strip being attached to a door panel and the outer circumference of the door frame 2, and the opening trim weather strip being attached to a flange of an opening of the vehicle body.

The glass run 110 has the body U-shaped in cross section comprising a vehicle-exterior side wall 120, a vehicle-interior side wall 130 and a bottom wall 140. A vehicle-exterior seal lip 150 is provided such that the seal lip 150 extends from the vicinity of the front end of the vehicle-exterior side wall 120 toward the inside of the U-shape in cross section of the glass run body.

Also from the vicinity of the front end of the vehicle-interior side wall 130, the vehicle-interior seal lip 160 extends toward the inside of the glass run body. U-shaped in cross section. The side wall 120, the vehicle-interior side wall 130 and the bottom wall 140 are inserted in the channel 3 of the door frame 2, and their respective outsides are contacted to the inside of the channel 3, so that the glass run 110 is held by the inner circumference of the door frame 2.

The door glass 5 slides at its end on the inside of the U-shape in cross section of the glass run 110, while it is sealed and held at both sides of its end by the vehicle-exterior seal lip 150 and the vehicle-interior seal lip 160 (see, for example, Japanese Patent Publication No. JP 2000-25462A (pp. 2, 3 and FIG. 2)). But, for ventilation, the vertical movement of the door glass 5 is sometimes stopped halfway of the door frame 2. At this time, the door glass 5 is not held at the upper side of the door frame 2, but the door glass 5 is held by only with the glass run 110 of both side ends. Therefore the door glass 5 might vibrate in its lateral direction (i.e. in the width direction of the vehicle). In particular, when the vehicle runs at high speed, the door glass 5 is attracted to the vehicle-exterior and displaced in a vehicle-exterior direction, or the door glass 5 is vibrated because of the vehicle running on rough roads (see, for example, Japanese Patent Publication No. JP 2002-19473A (pp. 5, 5 and FIG. 1(b)).

At this time, for preventing displacement or vibration, it is considered to make the vehicle-interior seal lip 160 and the vehicle-exterior seal lip 150 thick, and increase hardness so as to heighten holding force of the door glass 5 of the glass run 110. However, if making thick, resistance of the door glass 5 moving vertically becomes large so that the movement does not work well. Further, only with the vehicle-interior seal lip 160 and the vehicle-exterior seal lip 150 of a cantilever type, it is difficult to restrain the resistance of the door glass 5 moving vertically while holding strongly the door glass 5 at the interior of the glass run body U-shaped in cross section, and therefore, the door glass 5 vibrates so that the front ends of the seal lips 150, 160 often contact with the inside of the side wall and apart, causing abnormal noises.

If the displacement amount of the door glass 5 increases, the seal lips 150, 160 closely contact the side walls 120, 130 of the respective glass runs 110, while reaction force of the seal lips 150, 160 increases to prevent a more displacement of the door glass 5, but at parts of less displacement amount, the reaction force of the seal lips 150, 160 is not sufficient, so that it is insufficient to prevent the displacement or vibration of the door glass 5.

Further, It has been considered that the vehicle-interior seal lip 160 and the vehicle-exterior vehicle-interior seal lip 150 are formed to be hollow with respect to the vehicle-interior side wall 130 and the vehicle-exterior side wall 120 so as to hold the door glass 5 by means of the hollow seal lips.

However, in case of molding the hollow seal lips by extrusion forming, for preventing the hollow parts from being crushed owing to negative pressure when carrying out the extrusion forming, it has been necessary to continuously control an air at predetermined pressure and send it to the hollow parts, so that the molding work has been complicated to lower the rate of molding, and the productivity has not been good.

### SUMMARY OF THE INVENTION

Accordingly, it is an object of the invention to provide a vehicle glass run which may prevent displacement or vibration of the door glass by means of the seal lip even when the door glass places at any position in the glass run, exactly hold the door glass, smoothly move the door glass vertically by lowering the sliding resistance between the door glass and the seal lip, and prevent generation of abnormal noises.

For accomplishing the above mentioned object, a first aspect of the invention is a vehicle-glass run, which is mounted in the inner circumference of a door frame of a vehicle door for guiding a door glass moving vertically, and is provided with a glass run body U-shaped in cross section comprising an exterior side wall, an interior side wall and a bottom wall,

characterized in that the exterior side wall and the interior side wall are provided with an exterior seal lip and an interior seal lip which respectively extend toward the inner part of U-shape in cross section of the glass run body, and the exterior seal lip and the interior seal lip provide sealing between an exterior surface and an interior surface of the door glass inserted in the insides of the glass run body; the interior seal lip is formed to be longer than the exterior seal lip, and comprises the interior seal lip body extending from the interior side wall, a bent portion at a front end of the interior seal lip body, and a front end part of the interior seal lip extending from the bent portion, and the interior seal lip is formed such that the seal lip may contact at its front end portion the interior side wall, under a condition that the door glass is inserted in the inside of the glass run body; and the interior side wall has an interior side wall contact face which is treated to reduce sliding resistance in order to easily move when the interior seal lip contacts at its front end portion the interior side wall.

In the first aspect of the invention, the exterior side wall and the interior side wall are respectively provided with an exterior seal lip and an interior seal lip which extend toward the inner part of the U-shape in cross section of the glass run body. The exterior seal lip and the interior seal lip provide the sealing between an exterior surface and an interior surface of the door glass inserted in the insides of the glass run body, and at the same time, hold the ends of the door glasses. Therefore, the sealing between the door frame and the door glass may be provided.

The interior seal lip is formed to be longer than the exterior seal lip, and places the door glass outside of the vehicle, reducing difference in level in the outsides of the door and the door glass, reducing air resistance, and producing a good design. The interior seal lip comprises the interior seal lip body extending from the interior side wall, the bent portion at the front end of the interior seal lip body and the front end part of the interior seal lip extending from the bent portion, and the door glass may be held by elasticity of the interior seal lip body. Since the interior seal lip contacts at the bent portion the door glass, an area contacting with the door glass is small, so that the sealing property heightens, the sliding resistance lowers to make the vertical movement of the door glass easy and no abnormal noise is issued.

Further, the interior seal lip is formed to have a length such that the seal lip may contact at its front end portion the interior side wall, under a condition that the door glass is inserted in the inside of the glass run body, and therefore, the door glass is inserted between the interior seal lip and the exterior seal lip, and when pushing the interior seal lip in the direction of the interior side wall, the interior seal lip at once contacts at its front end the interior sidewall to generate reaction force, and even when the displacement amount of the door glass is small, the seal lip may hold the door glass, thereby to prevent the door glass from exceedingly displacing to the inside of the vehicle. The front end portion of the interior seal lip can be bent around the bent portion of the interior seal lip, so that vibration of the door glass can be absorbed.

Since the interior side wall is subjected to a treatment for reducing the sliding resistance in order to easily move when the interior seal lip contacts at its front end portion the interior side wall, the door glass pushes the interior seal lip in the direction of the interior side wall, and when the interior seal lip contacts at its front end portion the interior side wall, the interior seal lip easily slides on the surface treated for reducing the sliding resistance, and in response to vibration of the door glass, the interior seal lip slides to hold the door glass and at the same time to prevent generation abnormal noises when sliding.

In the invention, since the contact face of the interior side wall is formed to be a flat face from a part continuing with the bottom of the interior side wall until almost central portion of the interior side wall toward an opening side of the glass run body U-shaped in cross section, the door glass pushes the interior seal lip in the direction of the interior side wall, and when the interior seal lip contacts at its front end portion the interior side wall, the interior side wall can exactly receive the front end portion of the interior seal lip, and the interior side wall has no irregularity disturbing the sliding, and the interior side wall smoothly slides at the front end portion of the interior seal lip, and when sliding the door glass laterally, the interior side wall can flexibly absorb the sliding of the door glass.

In the invention, since the contact face of the interior side wall is a slant face which is formed between a projection of the interior side wall in a vicinity of central portion of the inner part of the interior side wall and the continuing part with the bottom wall, the door glass pushes the interior seal lip in the direction of the interior side wall, and when the interior seal lip contacts at its front end portion the interior side wall, the interior seal lip can contact the face at the slant angle, the face being contacted by the front end portion of the interior, and the front end portion of the interior can smoothly slide. In response to displacement or vibration of the door glass, the interior seal lip smoothly slides at its front end portion, so that the interior seal lip can exactly hold the door glass, and the interior seal lip can continuously contact at its front end portion the glass run, and no abnormal noises do not occur by sliding of the front end portion of the interior seal lip and the interior side wall.

In the invention, since the contact face of the interior side wall is a curved face which has a convex toward the interior between a vicinity of central portion of the inner part of the interior side wall and the continuing part with the bottom wall, when the interior seal lip contacts at its front end portion the contact face of the interior side wall and slides, the interior seal lip slides more smoothly while sliding downward.

In a modification of the invention, since the front end portion of the interior seal lip is formed to have a bendable length when contacting the contact face of the interior side wall and sliding on the surface thereof, when the interior seal lip contacts at its front end portion the contact face of the interior side wall, the interior seal lip can bend and cause elasticity, and it can push the door glass at appropriate force to prevent vibration of the door glass.

For accomplishing the above mentioned object, a second aspect of the invention is a vehicle glass run, which is mounted in the inner circumference of a door frame of a vehicle door for guiding a door glass moving vertically, and is provided with a glass run body U-shaped in cross section comprising an exterior side wall, an interior side wall and a bottom wall,

characterized in that the exterior side wall and the interior side wall are provided with an exterior seal lip and an interior seal lip, which respectively extend toward the inner part of U-shape in cross section of the glass run body, and the exterior seal lip and the interior seal lip provide the sealing between an exterior surface and an interior surface of the door glass inserted in the insides of the glass run body, and the interior seal lip is formed to be longer than the exterior seal lip, and comprises a root portion of the interior seal lip body extending from the interior side wall and a front end part of the interior seal lip extending from the root portion of the interior seal lip, thickness of the root portion is larger than that of the front end portion of the interior seal lip, connection between the root portion and the front end portion is made a bent portion of the interior seal lip, and in order to be a bent point, variation in thickness of the bent portion is made larger than those of other parts.

Since the interior seal lip comprises the root portion of the interior seal lip extending from the interior side wall and the front end portion of the interior seal lip extending from the root portion of the interior seal lip, it is possible to change the thickness or shapes at the root side and the front end side of the interior seal lip, and provide appropriate holding force and sealing force for the door glass in response to variances of the door glass within the glass run.

Since the thickness of the root portion of the interior seal lip is larger than that of the front end portion of the same, if an amount of the door glass displacing within the glass run is small, the root portion is difficult to deform, so that the root portion of the interior seal lip can hold the front end portion of the same at a predetermined position and can have the stably sealing force and the holding force. When the door glass largely displace, the root portion deforms together with the front end portion of the interior seal lip, and the root portion can have enough reaction force in relation with this displacement.

The interior seal lip comprises the root portion of the interior seal lip and the front end portion of the same extending from the root portion in the extending direction thereof in the same manner toward an inside of the U-shape in cross section of the glass run body. Therefore, the interior seal lip is shaped in plate or arc in cross section which is smooth particularly in the outside surface contacted by the door glass owing to the root portion and the front end portion, so that the door glass can easily slide.

Further, since the connection between the root portion of the interior seal lip and the front end portion of the same is made the bent portion of the interior seal lip, and in order to be the bent point, variation in thickness of the bent portion is made larger than those of other parts, and when the door glass contacts the glass run and the glass run pushes the interior seal lip, the interior seal lip is exactly bent around the bent portion of the seal lip. Therefore, even if the displacement of the door glass is slightly changed, the predetermined pushing force can be given to the door glass owing to deformation in the bent portion of the interior seal lip, enabling to hold the door glass and secure the sealing force. Neither reaction force nor sliding resistance to the door glass rapidly increases. The front end portion of the interior seal lip can bend around the bent portion, so that the seal lip can absorb vibration of the door glass.

In a modification of the second aspect of the invention, since the root portion of the interior seal lip has an almost constant thickness and is almost flat, even if the front end portion thereof is pushed by the door glass, the root portion of the seal lip is scarcely deformed and can hold the front end portion of the interior seal lip. Further, if the displacement of the door glass is large, the root portion becomes gradually curved after the seal lip deforms at the bent portion of the interior seal lip, and since the bent point thereof slowly moves from the front end of the root portion in the direction of a joining root, reaction force can be maintained in response to the door glass displacing.

Since the front end portion of the interior seal lip becomes gradually thinner as going to a front end, also when the seal lip deforms around the bent portion as mentioned above, the seal lip can flexibly contact the door glass along the surface, enabling to secure the sealing property and absorb vibration of the door glass.

In another modification of the second aspect of the invention, since the root portion of the interior seal lip is slightly curved in concave inside, and a central portion of the root portion is formed to be thinner than both ends thereof and thicker than the front end portion, even if the displacement of the door glass is small, the bent portion of the interior seal lip is bent to enable to give the predetermined reaction force to the door glass and prevent vibration of the door glass. Further, when the displacement of the door glass is large, and after the bent portion of the interior seal lip is bent, if this seal lip is further bent, since the central portion of the seal lip root portion can be bent, a load-curve in two steps can be obtained, so that the displacement and vibration of the door glass can be effectively absorbed.

A third aspect of the invention for solving the above mentioned problems is a vehicle glass run, which is mounted in the inner circumference of a door frame of a vehicle door for guiding a door glass moving vertically, and is provided with a glass run body U-shaped in cross section comprising an exterior side wall, an interior side wall and a bottom wall, characterized in that the exterior side wall and the interior side wall are provided with an exterior seal lip and an interior seal lip which respectively extend toward the inner part of U-shape in cross section of the glass run body, and the exterior seal lip and the interior seal lip provide sealing between an exterior surface and an interior surface of the door glass inserted in the insides of the glass run body, and an interior extension lip bends and extends from the front end of the interior seal lip toward the interior side wall, the interior extension lip is formed to be curved in convex toward the interior side wall.

Since the interior extension lip bends and extends from the front end of the interior seal lip toward the interior side wall, and the interior extension lip is formed to be curved in convex toward the interior side wall, it is possible to form a triangular false hollow part by means of the interior seal lip, interior extension lip and the interior side wall, and absorb vibration of the door glass caused during driving.

Further, the interior seal lip can contact as line-contact the door glass at its front end, i.e., at a portion bending the interior extension lip from the front end of the interior seal lip, so that the vertical movement of the door glass can be smoothly performed.

Since the interior extension lip is formed to be curved in convex toward the interior side wall, when the door glass pushes the interior seal lip, the interior extension lip can be easily bent to absorb vibration of the door glass.

Further in the third aspect of the invention, since the interior seal lip is formed such that when the door glass is positioned within the glass run body, the interior extension lip contacts at its front end the bottom wall, and therefore when the door glass contacts the interior seal lip, the front end of the interior extension lip is supported by the bottom wall, and the triangular false hollow part is formed by the interior seal lip, the interior extension lip and the interior side wall. Thus, the door glass can be steadily held by this triangular false hollow part and absorb vibration of the door glass.

A modification of the third aspect of the invention for solving the above mentioned problems is a vehicle glass run, which is mounted in the inner circumference of a door frame of a vehicle door for guiding a door glass moving vertically, and is provided with a glass run body U-shaped in cross section comprising an exterior side wall, an interior side wall and a bottom wall, characterized in that the exterior side wall and the interior side wall are provided with an exterior seal lip and an interior seal lip which respectively extend toward the inner part of U-shape in cross-section of the glass run body, and the exterior seal lip and the interior seal lip provide sealing between an exterior surface and an interior surface of the door glass inserted in the insides of the glass run body; an exterior extension lip bends and extends from the front end of the exterior seal lip toward the exterior side wall, and an interior extension lip bends and extends from the front end of the interior seal lip toward the interior side wall; and the exterior extension lip and the interior extension lip are respectively formed to be convex toward the exterior side wall and the interior side wall.

Since the exterior extension lip bends and extends from the front end of the exterior seal lip toward the exterior side wall, when the door glass contacts the exterior seal lip, the exterior extension lip contacts at the front end the inside of the exterior side wall and can support the front end of the exterior seal lip, so that the exterior extension lip can support at the front end the door glass.

Since the interior extension lip bends and extends from the front end of the interior seal lip toward the interior side wall, when the door glass contacts the interior seal lip, the interior extension lip contacts at the front end the inside of the bottom wall similarly to the exterior extension lip, and the interior extension lip can be supported at the front end by the bottom wall, so that an almost triangular false hollow part is formed by the interior seal lip, the interior extension lip and the interior side wall. Therefore, the door glass can be securely held by the triangular false hollow part to hold the interior seal lip.

In this manner, the door glass is held by the front end of the interior seal lip and the front end of the exterior seal lip. Therefore, vibration of the door glass can be absorbed.

When carrying out an extrusion forming, since the front end of the exterior extension lip and the exterior side wall are molded separately, while the front end of the interior extension lip and the interior side wall are formed separately, it is not necessary to form the hollow part, the extrusion forming is easy, the rate of forming can be improved, and productivity is good.

At the part where the exterior extension lip bends from the front end of the exterior seal lip, and at the part where the interior extension lip bends from the front end of the interior seal lip, the exterior seal lip and the interior seal lip contact as line-contact at the front ends the door glass so as to smoothly move the door glass vertically.

The exterior extension lip and the interior extension lip are respectively formed in curve to be convex toward the exterior side wall and the vehicle door side wall, and therefore, when the door glass pushes the interior seal lip, the exterior extension lip and the interior extension lip can be easily bent to absorb vibration of the door glass.

A another modification of the third aspect of the invention is the vehicle glass run, in which, when the door glass is inserted in the glass run body, the exterior extension lip contacts at the front end the inside of the exterior side wall, and the interior extension lip contacts at the front end a boundary part between a bottom projection and the inside of the interior side wall.

Further, in the interior seal lip, when the door glass is inserted in the glass run body, the interior extension lip contacts at the front end the boundary part between the bottom projection and the inside of the interior side wall, so that the interior seal lip securely holds the front end of the interior extension lip, and the triangular false hollow part can be formed by the interior seal lip, the interior extension lip and the interior side wall to elastically absorb vibration of the door glass, push the door glass outside of the vehicle, and reduce difference in level between the door glass and the door frame.

The invention provides the interior seal lip of the glass run with the body of the interior seal lip, the bent portion thereof and the front end portion of the same, and performs the treatment on the contact face of the interior side wall for reducing the sliding resistance, so that the interior side wall can exactly hold the door glass even when it stops halfway of the door frame, and at the same time, for reducing the sliding resistance, so that the door glass can smoothly move vertically.

The present invention bends and extends the interior extension lip from the front end of the interior seal lip toward the interior side wall, and since the interior extension lip is formed to be curved in convex toward the interior side wall, when the door glass is inserted into the inside of the glass run body, the invention may forms the almost triangular false hollow part, and since the interior extension lip is formed to be curved in convex toward the interior side wall, when the door glass pushes the interior seal lip, the interior extension lip can be easily bent to absorb vibration of the door glass.

The interior extension lip is supported at the front end by the bottom wall so as to hold the almost triangular false hollow part formed by the interior seal lip, the interior extension lip and the interior side wall. Thus, the door glass can be steadily held and absorb vibration of the door glass.

The present invention respectively bends and extends the exterior extension lip and the interior extension lip from the front ends of the exterior seal lip and of the interior seal lip toward the exterior side wall and the interior side wall. The exterior extension lip and the interior extension lip are formed to be curved in convex toward the exterior side wall and the interior side wall, and therefore, when the door glass is inserted in the inside of the glass run body, the exterior seal lip, the exterior extension lip, and the exterior side wall form the almost triangular false hollow part, and similarly, the interior seal lip, the interior extension lip and the interior side wall can form the triangular false hollow part. Thus, these triangular false hollow parts can hold the door glass securely and elastically at the front ends of the exterior seal lip and the interior seal lip.

Since the exterior extension lip and the interior extension lip are respectively curved in convex toward the exterior side wall and the interior side wall, when the door glass pushes the exterior seal lip and the interior seal lip, the exterior extension lip and the interior extension lip can be easily bent to absorb vibration of

### BRIEF DESCRIPTION OF THE DRAWINGS

FIG. 1 is a side view showing the vehicle door;

FIG. 2 is a cross sectional view of the conventional glass run;

FIG. 3 is a cross sectional view showing a glass run according to first embodiment before attaching to a vertical door frame;

FIG. 4 is a cross sectional view showing a glass run according to second embodiment before attaching to the door frame;

FIG. 5 is a cross sectional view showing the glass run according to the first embodiment after attaching to the door frame;

FIG. 6 is a cross sectional view showing the glass run according to the second embodiment after attaching to the door frame;

FIG. 7 is a cross sectional view showing a glass run according to third embodiment before attaching the door frame;

FIG. 8 is a cross sectional view showing a glass run according to fourth embodiment before attaching to the door frame;

FIG. 9 is a cross sectional view showing the glass run according to the third embodiment after attaching to the door frame;

FIG. 10 is a cross sectional view showing the glass run according to the fourth embodiment after attaching to the door frame;

FIG. 11 is a cross sectional view showing a glass run according to fifth embodiment, in which door glass is located at the central portion in the glass run body;

FIG. 12 is a cross sectional view showing a glass run according to fifth embodiment, in which door glass is located on the vehicle exterior side in the glass run body;

FIG. 13 is a cross sectional view showing a glass run according to sixth embodiment, in which door glass is located at the central portion in the glass run body;

FIG. 14 is a cross sectional view showing a glass run according to sixth embodiment, in which door glass is located on the vehicle exterior side in the glass run body;

FIG. 15 is a cross sectional view showing a glass run according to seventh embodiment, in which door glass is located at the central portion in the glass run body;

FIG. 16 is a cross sectional view showing a glass run according to seventh embodiment, in which door glass is located on the vehicle exterior side in the glass run body;

FIG. 17 is a cross sectional view showing a glass run according to eighth embodiment, in which door glass is located at the central portion in the glass run body; and

FIG. 18 is a cross sectional view showing a glass run according to eighth embodiment, in which door glass is located on the vehicle exterior side in the glass run body.

### DETAILED DESCRIPTION OF THE PREFERRED EMBODIMENTS

### First Embodiment

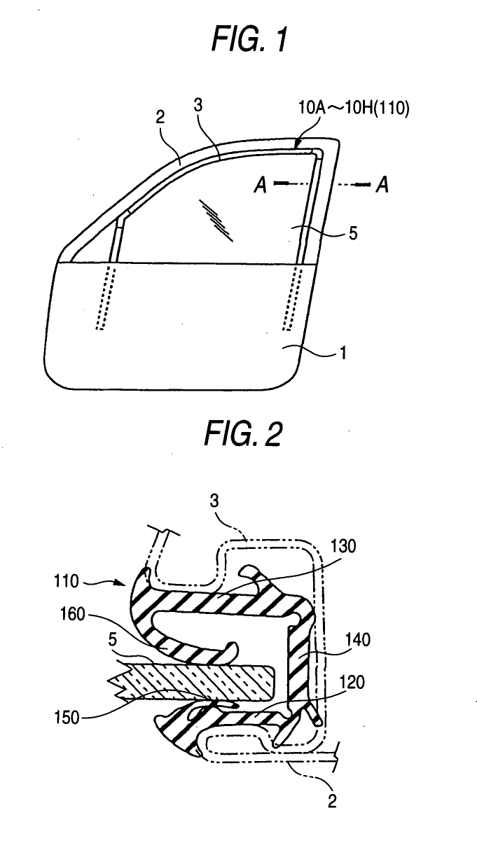

Explanation will be made to a first embodiment of the invention on the basis of FIGS. 1,3 through 6. FIG. 1 is a side view of the vehicle door. As shown in the same, the vehicle door 1 is attached with the door frame 2 at its upper part for moving vertically the door glass 5. That is, in the inner circumference of the door frame 2, a channel 3 is provided for attaching the glass run 10A so as to guide the door glass 5 moving vertically as well as seal the door glass 5 and the door frame 2.

The glass run 10A comprises an almost linear part formed by an extrusion forming and apart formed by molding for connecting the extruded part. The extruded part comprises a part to be attached to the upper part of the door frame 2, a part to be attached to a rear and vertical side of the door frame 2, and a part to be attached to a front and vertical side of the door frame 2. The molded parts connect these extruded parts in shape corresponding to the door frame 2 to be the parts attached to corner portions of the door frame 2.

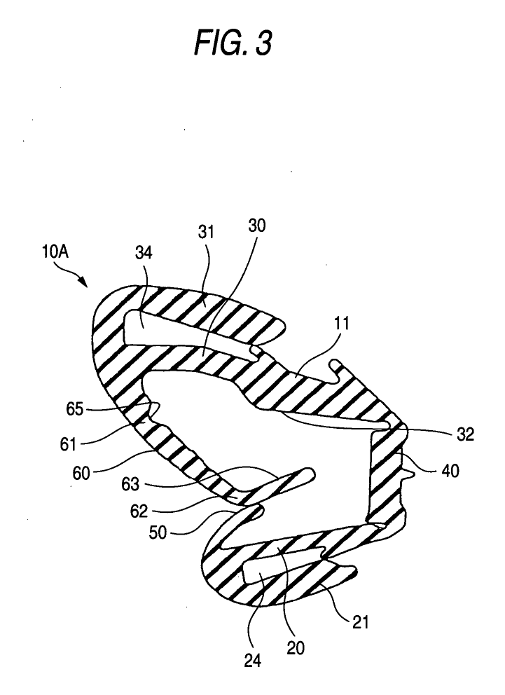

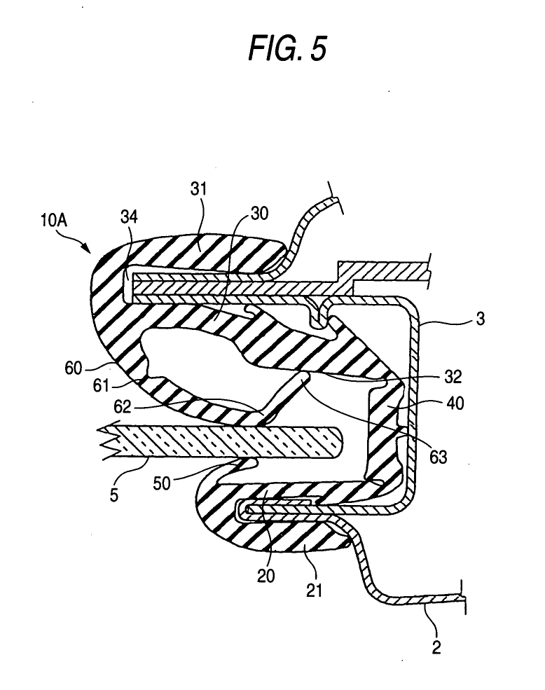

FIG. 3 shows a cross sectional view along A-A line of FIG. 1 of the extruded part attached to the vertical side of the door frame 2. FIG. 5 is a cross sectional view along A-A line of FIG. 1 when attaching the glass run 10A to the door frame 2. The glass run body 11 comprises the vehicle-exterior side wall 20, the vehicle-interior side wall 30 and the bottom wall 40, and is formed substantially in U shape in cross section. The vehicle-interior seal lip 60 extends from the front end portion of the vehicle-interior side wall 30 toward the inside formed in U shape in cross section of the glass run body 11. The vehicle-interior cover lip 31 extends in the direction of the vehicle-interior. The vehicle-exterior seal lip 50 extends from the front end portion of the vehicle-exterior side wall 20 toward the inside formed in U shape in cross section of the glass run body 11. The vehicle-exterior cover lip 21 extends at its front end portion of thee side wall 20 in the direction of the vehicle-exterior.

As shown in FIG. 5, when attaching the glass run 10A to the channel 3 of the door frame 2, the vehicle-interior side wall of the channel 3 is inserted in a groove 34 of the vehicle-interior side wall between the outside of the vehicle-interior side wall 30 and the inside of the vehicle-interior cover lip 31, while the vehicle-exterior side wall of the channel 3 is inserted in a groove 24 of the vehicle-exterior side wall between the outside of the vehicle-exterior side wall 20 and the inside of the vehicle-exterior cover lip 21, so that the channel 3 is covered at its front end and the glass run 10A is held. When the glass run 10A is attached to the channel 3, the vehicle-exterior side wall 20, the vehicle-interior wall side 30 and the bottom wall 40 contact with their outsides the inside of the channel 3 and securely support the glass run 10A.

The vehicle-interior seal lip 60 has the body 61 of the vehicle-interior seal lip, the bent portion 62 thereof, and the front end portion 63 of the same, the body 61 extending from the front end of the vehicle-interior side wall 30 in the direction of the inside of the U-shape in cross section, the bent portion 62 being bent from the front end of the body 61 to the bottom wall 40, otherwise, in the direction of the connection with the bottom wall 40 of the vehicle-interior side wall 30, and the front end portion 63 extending from the bent portion 62 longer than a conventional front end portion, that is, extending from the bent portion 62 with a length contacting the vehicle-interior side wall, when the door glass contacts the vehicle-interior seal lip.

The length of the front end portion 63 of the vehicle-interior seal lip may be formed to be bendable in curve when the front end portion 63 contacts the contact face 32 of the vehicle-interior side wall and slides on its surface. Therefore, when the front end portion 63 contacts the contact face 32, it curves and causes elasticity, and the vehicle-interior seal lip 60 pushes the door glass 5 with appropriate force so as to prevent vibration of the door glass 5.

Since the vehicle-interior seal lip body 61 is longer and thicker in cross section than the vehicle-exterior seal lip 50, the door glass 5 can be brought near to the vehicle-exterior side wall 20 in the inside of the U-shape in cross section of the glass run body 11, that is, the vehicle-exterior of the door frame 2, reducing difference in level in the vehicle-exterior surface between the door glass 5 and the door frame 2, and reducing the air resistance, so that the outer surface of the vehicle body is made smooth and looks preferable in appearance.

The vehicle-interior seal lip body 61 is formed to be flat in cross section, or slightly curved in convex toward the door glass 5, and therefore when the door glass 5 moves upward and contacts at its front end the vehicle-interior seal lip body 61 and slides thereon, it is elastically bent as shown in FIG. 5, and enters between the vehicle-interior seal lip 60 and the vehicle-exterior seal lip 50. On a part of the vehicle-interior seal lip body 61, which contacts the door glass 5, a low friction member is applied to reduce the sliding resistance as later mentioned. The vehicle-interior seal lip body 61 may be provided on the inside face with a concave 65 grooved in the lengthwise direction of the vehicle-interior seal lip, the concave 65 increasing flexibility of the vehicle-interior seal lip body 61.

The vehicle-interior seal lip body 61 has at its front end the vehicle-interior seal lip bent portion 62 bending toward the bottom wall 40 or in the direction of the connection with the bottom wall 40 of the vehicle-interior side wall 30. When the door glass 5 contacts the vehicle-interior seal lip 60 and enters into the interior of the U-shape in cross section, the door glass 5 contacts the vehicle-interior seal lip bent portion 62 as shown in FIG. 5, and therefore, since the contacting area with the door glass 5 is small, the sliding resistance can be reduced to ensure the sealing.

When the door glass 5 contacts the vehicle-interior seal lip 60 from the vehicle-interior seal lip bent portion 62, the vehicle-interior seal lip front end portion 63 extends from the bent portion 62 at a length contacting the vehicle-interior side wall 30 toward the bottom wall 40 or in the direction connecting the bottom wall 40 of the vehicle-interior side wall 30. When the door glass 5 is inserted at a predetermined position of the inside of the U-shape in cross section, the vehicle-interior seal lip front end portion 63 is formed having a length contacting at its front end the inside of the vehicle-interior side wall 30 or separating slightly therefrom. When the door glass 5 slightly displaces or vibrates, the vehicle-interior seal lip front end portion 63 contacts at its front end the inside of the vehicle-interior side wall 30, that is, the inside of the U-shape in cross section. Therefore, reaction force is caused between the vehicle-interior seal lip front end portion 63 and the vehicle-interior side wall 30, thereby enabling to support deformation of the vehicle-interior seal lip 63 and prevent displacement of the door glass 5.

If the length of the vehicle-interior seal lip front end portion 63 is determined to be bendable when contacting the contact face 32 of the vehicle-interior side wall and sliding on the surface, the front end portion 63 can be curved and smoothly slides on the contact face 32.

In the embodiment of FIG. 3, the vehicle-interior side wall 30 contacted by the front end portion 63 is provided with a surface performed with a treatment for reducing the sliding resistance on the contact face 32 of the vehicle-interior side wall contacted by the front end portion 63 of the vehicle-exterior seal lip, and the contact face 32 is formed to be flat and thick until the half of the vehicle-interior side wall 30 in an opening direction of U-shape in cross section, that is, toward the front end.

Since the contact face 32 of the vehicle-interior sidewall is flat, it has neither concave nor convex hooking the front end portion 63 of the vehicle-interior seal lip when contacting the face 32. Further, since performing the treatment for reducing the sliding resistance on the contact face 32 of the vehicle-interior side wall, the front end portion 63 easily slides and can restrain vibration or displacement of the door glass 5. Further, if performing the same at the front end of the vehicle-interior seal lip front end portion, the front end portion 63 easily slides on the contact face 32, and can restrain vibration or displacement of the door glass 5. In case of performing the same at the front end of the vehicle-interior seal lip 60, the sliding resistance can be more reduced.

In case the contact face 32 of the vehicle-interior side wall is formed in a curved face becoming a convex in the vehicle-interior inside provided between the a vicinity of central portion of the inside of the vehicle-interior side wall 30 and the part continuing with the bottom wall 40, the front end portion 63 of the vehicle-interior seal lip can slide more smoothly as going to the lower side.

The vehicle-exterior seal lip 50 extends from the front end of the vehicle-exterior side wall 20 toward inside of the U-shape in cross section of the glass run body 11 that, while the vehicle-exterior cover lip 21 extends outside of the vehicle at the front end of the vehicle-exterior side wall 20. The vehicle-exterior side wall of the channel 3 is inserted into the groove 24 in the vehicle-exterior side wall that is defined by an outer face of the vehicle-exterior side wall 20 and an inner face of the vehicle-exterior cover lip 21, so that the glass run 10A is held. The vehicle-exterior seal lip 50 is integrally provided at the front end inside of the vehicle-exterior side wall 20. The vehicle-exterior seal lip 50 is shaped almost in plate, shorter and thinner in cross section than the vehicle-interior seal lip 60. Since the vehicle-exterior seal lip 50 is shorter than the vehicle-interior seal lip 60, the door glass 5 can be brought near to the door frame 2 in the inside of U-shape in cross section of the glass run 10A, reducing the difference in level in the door glass 5 and the door frame 2, and reducing air resistance, so that the outer surface of the vehicle body is made smooth and looks preferable in appearance.

The contact face 32 of the vehicle-interior side wall 30 is, as mentioned above, carried out with the treatment for reducing the sliding resistance, and this treatment is also sufficient with applying a low friction member on the surface of the contact face, or forming of the low friction member integrally on the surface by simultaneously extruding the low friction member and glass run 10A. As far as being low friction materials, those are available as the low friction member, for example, usable are TPO sheet, non-woven fabric of fluorine contained resin, polyethylene sheet, urethane coat, or silicone sheet. The treatment for reducing the sliding resistance are preferably carried out also on the vehicle-exterior seal lip 50, vehicle-interior seal lip 60, and the front end portion 63 of the vehicle-interior seal lip other than the contact face 32 of the vehicle-interior side wall as mentioned above.

### Second Embodiment

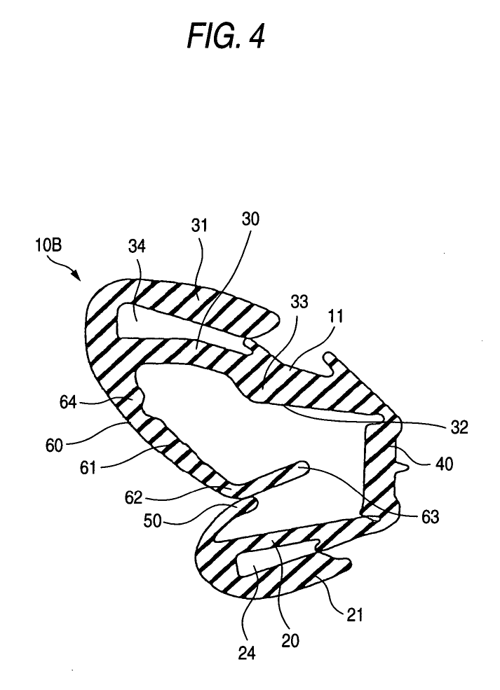

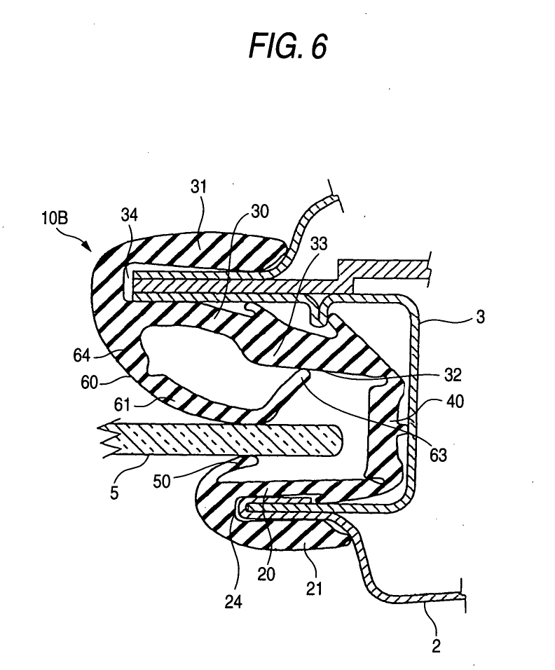

Next, explanation will be made to a second embodiment on the basis of FIGS. 4 and 6. FIG. 6 is a cross sectional view along A-A line of FIG. 1 when attaching the glass run 10B to the channel 3 of the door frame 2. The second embodiment is different from the first embodiment in the contact face 32 of the vehicle-interior side wall 30 of the glass run 10B and the vehicle-interior seal lip body 61, and is similar in other parts. Therefore, explanations for the other parts than the contact face 32 and the vehicle-interior seal lip body 61 will be omitted. The contact face 32 is provided with a projection 33 of the vehicle-interior side wall in a vicinity of central part inside of the vehicle-interior side wall 30. There is a curved surface like an arc-shape in cross section formed to be continuous from the projection 33 to the bottom wall 40.

Therefore, the front end portion 63 of the vehicle-interior seal lip has a length of contacting the slope of the projection 33 of the vehicle-interior side wall of the inside of the vehicle-interior side wall 30, or slightly separating when the door glass 5 is inserted in the predetermined position of the inside of the U-shape in cross section of the glass run 10B. When the door glass 5 slightly displaces or vibrates, the vehicle-interior seal lip front end portion 63 contacts at its front end the slope of the vehicle-interior side wall 30, that is, the inclined surface curved like the arc-shape in cross section formed to be continuous from the projection 33 to the bottom wall 40. Therefore, reaction force is caused between the vehicle-interior seal lip front end portion 63 and the vehicle-interior side wall 30, thereby enabling to support deformation of the vehicle-interior seal lip and prevent displacement of the door glass 5. At this time, the vehicle-interior seal lip contacts at its front end portion 63 the slope curved in U-shaped cross section, and owing to contacting with the slope and an angle, the sliding is smooth and easily absorbs displacement or vibration of the door glass 5.

The body 61 of the vehicle-interior seal lip 60 has a reinforcing part 64 of the vehicle-interior seal lip formed to be thick in the vicinity continuing with the vehicle-interior side wall 30. Therefore, when the door glass 5 moves from a predetermined position, and pushes the vehicle-interior seal lip 60 in the direction of the vehicle-interior side wall 30 to deform the seal lip 60, if the displacing distance of the door glass 5 is short, the front end portion 63 of the vehicle-interior seal lip 61 and the bent portion 62 of the same can be easily bent. When the door glass 5 is largely displaced and the moving distance within the glass run 10B is long, the seal lip deforms until a root of the vehicle-interior seal lip body 61, but since the force holding the door glass 5 may be increased owing to the reinforcing part 64 of the vehicle-interior seal lip formed thickly, the door glass 5 can be prevented from the displacement becoming large.

Next reference will be made to a production method of the glass run 10B according to the invention. The glass run 10B is formed firstly in an extruded part by using a soft solid material. When extrusion forming, the glass run 10B is molded under a condition of slightly opening the front end portion as an opening in substantially U-shape in cross section. Thereby, when attaching to the channel 3, a pressing force is provided against the side wall of the channel 3, and further workings are easily done to the vehicle-exterior side wall 20, vehicle-interior side wall 30, bottom wall 40, vehicle-exterior seal lip 50, and coating of the low friction member to the vehicle-interior seal lip.

As the molding materials, a synthetic rubber, thermo-plastic elastomer, or soft synthetic resin are employed, and for example, as the synthetic rubber, EPDM rubber is used, as the thermoplastic elastomer, polyolefin based elastomer is used, and as the soft synthetic resin, soft vinyl chloride or the like is used. In the case of synthetic rubber, after the extrusion forming, it is sent to a vulcanization chamber in which the synthetic rubber is heated by a hot blast or high frequency. The thermoplastic elastomer and the soft synthetic resin are cooled and solidified, then are cut into predetermined sizes, and the production of the extruded parts is completed.

The forming of the molded parts is carried out by holding the extruded parts as above produced at their ends between forming molds for forming the extruded parts, and injecting the solid materials into the cavity of the forming molds. The cross sectional shape of the molded part formed by the mold is almost the same as that of the extruded. It is preferable that the formed material employs materials having the same quality as that of the material used to the extrusion forming. The synthetic rubber is injected in the mold and vulcanized by heating the mold. At this time, since the extruded part and the formed part can be adhered by vulcanization, using the same materials or the same kind of materials, these parts are integrally solidified. The thermoplastic elastomer and the soft synthetic resin are melted when poured, and therefore, the extruded part and the formed part are integrally welded.

### Third Embodiment

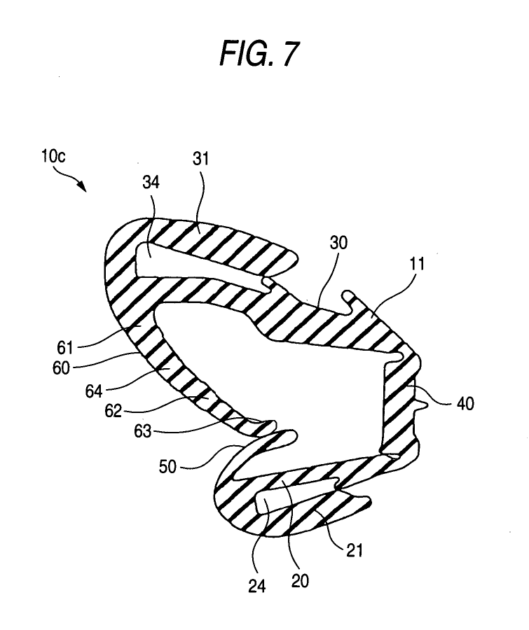

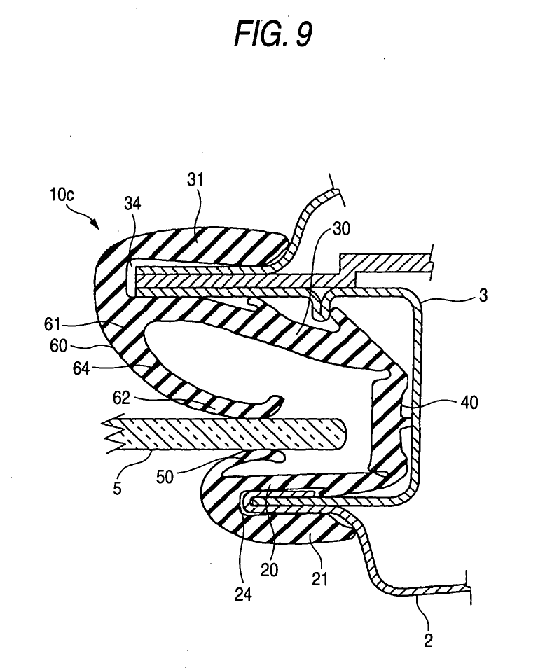

A third embodiment will be explained on the basis of FIGS. 7 and 9.

A cross sectional shape of an extruded part to be attached to a vertical side of the door frame 2 is shown in FIG. 7.

The vehicle-interior seal lip 60 extends from the vicinity of the front end of the vehicle-interior side wall 30 toward the inside of the U-shape in cross section of the glass run body 11. A vehicle-interior cover lip 31 extends in the vehicle-interior direction at the front end of the side wall 30.

The vehicle-exterior seal lip 50 extends from the front end of the vehicle-exterior side wall 20 toward the inside of the U-shape in cross section of the glass run body 11. A vehicle-exterior cover lip 21 extends in the vehicle-exterior direction at the front end of the vehicle-exterior side wall 20.

As shown in FIG. 9, when attaching the glass run 10C to the channel 3 of the door frame 2, the vehicle-interior side wall of the channel 3 is inserted in a groove 34 of the vehicle-interior side wall between the outside of the vehicle-interior side wall 30 and the inside of the vehicle-interior cover lip 31, while the vehicle-exterior side wall of the channel 3 is inserted in a groove 24 of the vehicle-exterior side wall between the outside of the vehicle-exterior side wall 20 and the inside of the vehicle-exterior cover lip 21 so as to cover the front end of the channel 3 and support the glass run 10C. When the glass run 10C is attached to the channel 3, the vehicle-exterior side wall 20, the vehicle-interior wall side 30 and the bottom wall 40 contact at their respective outsides the inside of the channel 3 and securely support the glass run 10C.

The vehicle-interior seal lip 60 is formed to be longer and thicker than the vehicle-exterior seal lip 50, and therefore, as shown in FIG. 9, the door glass 5 can be positioned outside of the vehicle, reducing difference in level in an outer surface seen from the vehicle-exterior of the door 1 and the door glass 5, and reducing wind noises and air resistance while driving, so that the outer surface of the vehicle body looks preferable in design.

In particular, if providing the shape of the vehicle-interior seal lip 60 of the invention to at least the glass run 10C attached in the vertical side of the door frame 2, when the door glass 5 stops halfway in the door frame 2, that is, half-opens, the door glass 5 can be held at the vertical side and prevented from displacing or vibrating.

The seal lip 60 of the vehicle-interior comprises the root portion 61 of the vehicle-interior seal lip and the front end portion 62 of the same, the root portion 61 extending from the vehicle-interior side wall 30 in the direction of the inside of the U-shape in cross section of the glass run body 11, and the bent portion 62 extending from the root portion 61 of the vehicle-interior seal lip in the extending direction thereof toward the inside of the U-shape in cross section of the glass run body 11. Therefore, the vehicle-interior seal lip 60 is shaped in plate or arc in cross section which is smooth in the outside surface contacted by the door glass owing to the root portion 61 and the front end portion 62, so that the door glass can easily slide.

The root portion 61 of the vehicle-interior seal lip is formed until an almost half length of the vehicle-interior seal lip 60, and almost flat in thickness from the vehicle-interior side wall 30, the thickness being larger than the front end portion 62 of the vehicle-interior seal lip. Therefore, even if the front end portion 62 is pushed by the door glass 5, since the root portion 61 is thick, the front end portion 62 is less deformed but bent at the bent portion 64 of the vehicle-interior seal lip as later mentioned. Even when deformation of the door glass 5 is small, the door glass 5 is supported at the predetermined reaction force, and the door glass 5 is slightly displaced, while the root portion 61 is not deformed, so that the front end portion 62 of the vehicle-interior seal lip is supported at the predetermined position.

Further, if the displacement of the door glass 5 becomes large within the glass run 10C, after the vehicle-interior seal lip 60 is deformed at the bent portion 64, the root portion 61 of the vehicle-interior seal lip is slowly bent, and since the root portion 61 is almost flat in thickness, the bent point thereof gradually moves from the front end of the root portion 61 in the direction of the root, and can maintain the reaction force supporting the door glass 5 in response to the displacement of the door glass 5.

The front end portion 62 of the vehicle-interior seal lip 60 is formed at the almost half length of the vehicle-interior seal lip 60, and as coming near to the front end, the thickness becomes gradually thinner. Therefore, the door glass 5 contacts the front end portion 62 of the seal lip, and as mentioned later also when the seal lip 60 is deformed at the bent portion 64, the seal lip can flexibly contact the door glass along the surface thereof, enabling to secure the sealing property and absorb vibration of the door glass.

The connection between the root portion 61 of the vehicle-interior seal lip and the front end portion 62 of the same is made a vehicle-interior bent portion 64, and in order to be the bent point when the door glass 5 contacts and bends the seal lip 60, variation in thickness of the bent portion is made larger than those of other parts of the seal lip 60. As shown in FIG. 7, at the inside of the bent portion 64, the thickness becomes thin in curve.

Since, at the bent portion 64 of the seal lip, the cross section rapidly decreases in curve, the door glass 5 contacts the glass run 10C, and when the door glass 5 pushes the seal lip 60, stress is concentrated on the bent portion 64 of the vehicle-interior sea lip, the seal lip 60 is securely bent, and therefore even if the displacement of the door glass 5 is varied, until the door glass displaces at the root portion 61 of the vehicle-interior seal lip, it is possible to give the predetermined pushing pressure to the door glass 5 by the bending of the bent portion 64, so that the sealing force can be maintained, and at the same time the sliding resistance of the door glass 5 is not increased. Since the front end portion 62 of the seal lip can be deformed by the bending of the bent portion 64, it closely contacts the door glass 5 and can absorb the vibration of the door glass 5.

The root portion 61 of the vehicle-interior seal lip is formed to be flat in cross section, or slightly curved in convex toward the door glass 5, and therefore when the door glass moves upward and contacts at its front end the root portion 61, it is elastically bent as shown in FIG. 6 and slides on the surface of the root portion 61 of the vehicle-interior seal lip, and it is inserted inside of the glass run body 11 and can enter between the vehicle-interior seal lip 60 and the vehicle-exterior seal lip 50. On a part where the vehicle-interior seal lip 60 and the vehicle-exterior seal lip 50 contacts, a low friction member is applied as later mentioned so that the sliding is smoothly carried out.

The vehicle-exterior seal lip 50 extends from the front end of the vehicle-exterior side wall 20 toward the inside of the U-shape in cross section of the glass run body 11, while the vehicle-exterior cover lip 21 extends outside of the vehicle at the front end of the vehicle-exterior side wall 20. The vehicle-exterior side wall of the channel 3 is inserted in the groove 24 of the vehicle-exterior side wall between the outside of the vehicle-exterior side wall 20 and the inside of the vehicle-exterior cover lip 21, so that the glass run 10C is held. The vehicle-exterior seal lip 50 is integrally provided at the front end inside of the vehicle-exterior side wall 20.

The vehicle-exterior seal lip 50 is shaped almost in plate, or in arc of large radius of curvature, and shorter in the lip and thinner than the vehicle-interior seal lip 60, so that the door glass 5 can be brought near to the vehicle-exterior of the door frame 2 in the inside of the U-shape in cross section of the glass run body 11, reducing difference in level in the door glass 5 and the door frame 2, and reducing the air-cutting noises and the air resistance, and the outer surface of the vehicle body is made smooth and looks preferable in appearance.

### Fourth Embodiment

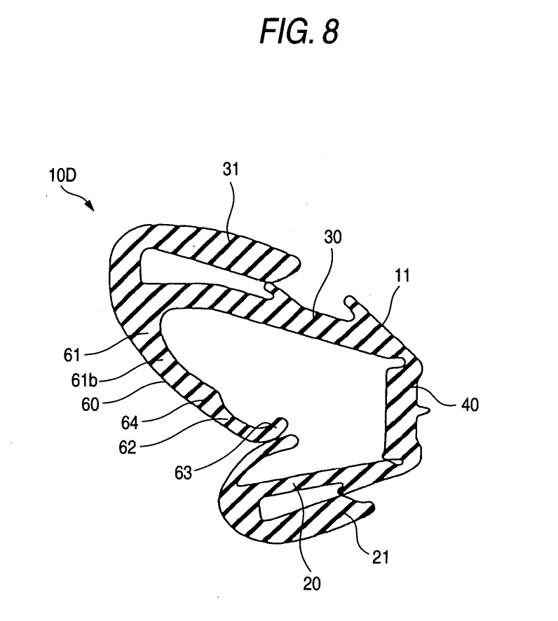

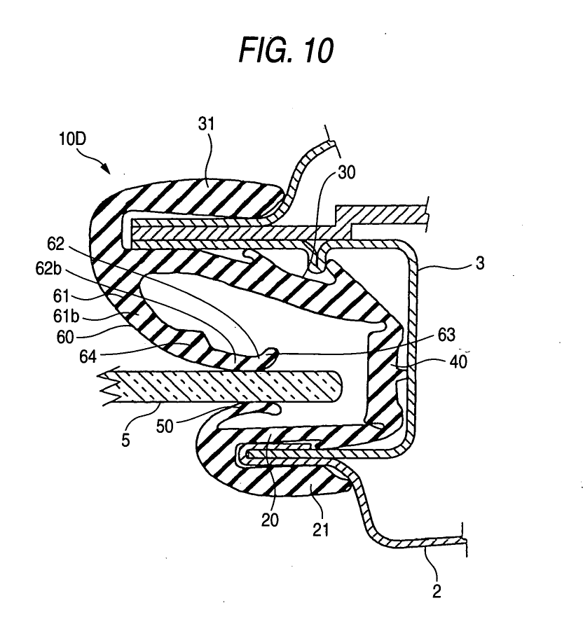

Next, explanation will be made to a four the mbodiment on the basis of FIGS. 8 and 10. FIG. 8 is a cross sectional view along A-A line of FIG. 1, and FIG. 10 is a cross sectional view along A-A line of FIG. 1 when attaching the glass run 10D to the channel 3 of the door frame 2 (only the glass run 10D). The fourth embodiment is different from the first embodiment in the shape of the vehicle-interior seal lip 60, and is similar in other parts. Therefore, explanations for the other parts than the vehicle-interior seal lip 60 will be omitted.

The vehicle-interior seal lip 60 comprises the root portion 61 of the vehicle-interior seal lip and the front end portion 62 of the same, the root portion 61 extending from the vehicle-interior side wall 30 in the direction of the inside of the U-shape in cross section of the glass run body 11, and the bent portion 62 extending from the root portion 61 of the vehicle-interior seal lip in the extending direction thereof toward the inside of the U-shape in cross section of the glass run body 11. Therefore, the vehicle-interior seal lip 60 is shaped in plate or arc in cross section which is smooth in the outside surface contacted by the door glass owing to the root portion 61 and the front end portion 62, so that the door glass can easily slide.

Since the root portion 61 of the vehicle-interior seal lip 60 is slightly curved in concave the inside, and the central portion 61b of the root portion is formed to be thinner than both ends thereof, that is, than the connection with the vehicle-interior side wall 30 and the connection with the front end portion 62 of the vehicle-interior seal lip, and thicker than the curved portion 62b of the front end of the vehicle-interior seal lip which is slightly curved in concave at the inside of the front end portion 62 of the vehicle-interior seal lip. Therefore, when the displacement of the door glass 5 is large, and after the bent portion 64 of the vehicle-interior seal lip is bent, if the seal lip is further bent, since the central portion 61b of the seal lip root portion can be bent, it is possible to obtain the loading curves in two steps of the load by bending of the bent portion 64 of the vehicle-interior seal lip and the load of the central portion 61b of root portion of the same, so that the displacement and vibration of the door glass can be effectively absorbed.

The front end portion 62 of the vehicle-interior seal lip 60 is slightly curved in the concave inside. Therefore, the thickness can be rapidly varied at the connecting part with the bent portion 64 of the vehicle-interior seal lip, so that the bent portion 64 can be easily bent. When the front end portion 62 contacts the glass run 10D, the front end portion 62 is easily urged at the surface to the face of the glass run 10D, enabling to secure the sealing property.

Further, there is provided a projection 63 of the vehicle-interior seal lip bending from the front end portion 62 of the seal lip in the direction of the vehicle-interior side wall 30. Therefore, when the door glass 5 largely displaces to push the vehicle-interior seal lip 60 toward the side wall 30, the projection 63 contacts the vehicle-interior side wall 30 to enable to support deformation of the vehicle-interior seal lip 60 and prevent a further displacement of the door glass 5. The projection 63 serves as a cushion to enable to absorb the vibration of the door glass 5. Further, since the seal lip 60 does not closely adhere the vehicle-interior side wall 30, any abnormal noises are not issued which are caused when the seal lip 60 and the vehicle-interior side wall 30 peel off from the close adherence. By the way, the projection 63 and the side wall 30 are performed on their surfaces with the treatment for reducing the sliding resistance.

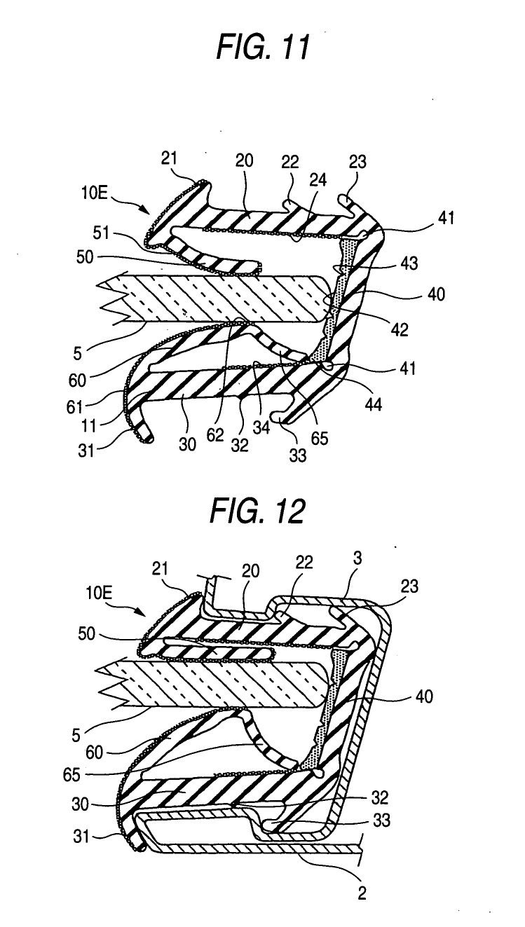

Explanation will be made to a fifth embodiment and a sixth embodiment of the invention on the basis of FIGS. 11 through 14.

### Fifth Embodiment

The fifth embodiment is described on the basis of FIGS. 11 through 14. Incidentally, although the attached state of the glass run is similar to the previous embodiments, the interior/exterior of the vehicle in these figures is shown in the opposite manner to those in FIG. 3 etc.

The glass run 10E of this embodiment is also formed with U-shape in cross section, having the glass run body 11 comprising the vehicle-exterior side wall 20, the vehicle-interior side wall 30 and the bottom wall 40. The vehicle-interior seal lip 60 extends from the front end of the vehicle-interior side wall 30 toward the inside of U-shape in cross section of the glass run body 11. The vehicle-interior cover lip 31 extends in the vehicle-interior direction at the front end of the vehicle-interior side wall 30. The vehicle-exterior seal lip 50 extends from the front end of the vehicle-exterior side wall 20 toward the inside of U-shape in cross section of the glass run body 11. The vehicle-exterior cover lip 21 extends in the vehicle-interior direction at the front end of the vehicle-exterior side wall 20.

As shown in FIG. 12, when attaching the glass run 10E to the channel 3 of the door frame 2, the vehicle-interior of the channel 3 contacts a vehicle-interior holding projection 32 of the vehicle-interior-side-wall 30. The vehicle-interior cover lip 31 and the vehicle-interior holding lip 33 hold the vehicle-interior side wall of the channel 3, attach the vehicle-interior side wall 30, and simultaneously provide the sealing between the glass run 10E and the channel 3.

The channel 3 contacts at the inside of the vehicle-exterior the outside of the vehicle-exterior side wall 20. The vehicle-exterior cover lip 21 and a first vehicle-exterior holding lip 22 support the vehicle-exterior side wall of the channel 3, and attach the vehicle-exterior side wall 20. Simultaneously, a second vehicle-exterior holding lip 23 provides the sealing between the glass run 10E and the channel 3 while contacting the inside of the channel 3.

When the glass run 10E is attached to the channel 3, the vehicle-exterior side wall 20, the vehicle-interior side wall 30, and the bottom wall 40 become the U-shape in cross section, and an outside of the U-shape in cross section contacts the inside of the channel 3, so that the glass run 10E is steadily held.

The vehicle-interior seal lip 60 extends from the front end of the vehicle-interior side wall 30 in the direction of the inside of the U-shape in cross section of the glass run body 11. At an inside joint part in relation with the vehicle-interior side wall 30 of the vehicle-interior seal lip 60, a thin part may be provided. With the thin part, the vehicle-interior seal lip 60 is made easily bent. The vehicle-interior seal lip 60 and the vehicle-interior cover lip 61 are provided on the surfaces thereof continuously with the low slide members, and a low friction face 61 of the vehicle-interior seal lip is formed. In the embodiment of FIGS. 11 and 12, as later mentioned, the low friction face 61 of the vehicle-interior seal lip is harder than a material composing the glass run body 11.

The vehicle-interior extension lip 65 extends from the front end of the vehicle-interior seal lip 60. The vehicle-interior extension lip 65 is bent from the front end of the vehicle-interior seal lip 60 toward the vehicle-interior side wall 30, and this bent part becomes a bent part 62 of the vehicle-interior seal lip. The vehicle-interior extension lip 65 is as a whole curved in a bow shape and formed as a convex toward the vehicle-interior side wall 30. The length of the vehicle-interior extension lip 65 is determined such that the vehicle-interior extension lip 65 can contact the boundary part between the vehicle-interior side all 30 and the bottom wall 40 even if the door glass 5 vibrates to the most vehicle-exterior, when the door glass 5 enters at the end part into the inside of the glass run body 11. Thereby, when the door glass 5 is inserted in the glass run body 11, it is possible to assuredly form the triangular false hollow part by the vehicle-interior seal lip 60, the vehicle-interior extension lip 65 and the vehicle-interior side wall 30.

When the door glass 5 is inserted into the inside of the glass run body 11, the peak of the triangle of the false hollow part, that is, the bent part 62 of the vehicle-interior seal lip contacts as line-contacts the side face of the door glass 5, and can provide the sealing between the door glass 5 and the glass run 10E. Thus, the door glass 5 can smoothly move up and down. Further, since the vehicle-interior seal lip 60 is provided on the surface with the low friction member as mentioned above, the door glass can more smoothly move up and down.

The vehicle-interior side wall 30 is similarly provided with the low friction member at the inside portion where the vehicle-interior extension lip 65 slides at its front end. Therefore, the vehicle-interior extension lip 65 can slide smoothly at its front end.

Since the vehicle-interior extension lip 65 is thinner than the vehicle-interior seal lip 60, and is curved in convex in the direction of the vehicle-interior side wall 30, even when the door glass 5 vibrates, the vehicle-interior extension lip 65 can be easily bent and deformed to absorb vibration. Further, the triangular false hollow part can be assuredly formed by the vehicle-interior seal lip 60, the vehicle-interior extension lip 65 and the vehicle-interior side wall 30, and therefore this triangular false hollow part is elastically deformed, enabling to secure the predetermined force of holding the door glass 5. In addition, the vehicle-interior extension lip 65 contacts the vehicle-interior side wall 30 and the bottom wall 40 when the door glass 5 is inserted, and it does not separate from the vehicle-interior side wall 30, and accordingly the abnormal noise by separation is not generated.

As shown in FIG. 12, the door glass 5 reduces difference in level with the outside face of a door panel, so that an air flows smoothly and an exterior appearance looks preferable in appearance. Therefore, the door glass 5 is preferably provided outside of the vehicle. Also in this case, the vehicle-interior extension lip 65 contacts at its front end the boundary part between the vehicle-interior side wall 30 and the bottom wall 40 and elastically holds the door glass 5.

When the door glass 5 biases to the vehicle-interior, the portion of the vehicle-interior extension lip 65 is bent or compressed to absorb displacement or vibration of the door glass 5.

The vehicle-exterior seal lip 50 extends from the front end of the vehicle-exterior side wall 20 in the direction of the inside of the U-shape in cross section of the glass run body 11. At the inside joint part in relation with the vehicle-exterior side wall 20 of the vehicle-exterior seal lip 50, a thin part may be provided similarly to the vehicle-interior seal lip 60. With the thin part, the vehicle-exterior seal lip 50 is made easily bent. The low slide members are continuously provided on the surfaces of the vehicle-exterior seal lip 50 and the vehicle-exterior cover lip 21 so that a low friction member 51 of the vehicle-exterior seal lip is formed. The low friction member 51 of the vehicle-exterior seal lip is harder than a material composing the glass run body 11.

When the door glass 5 is inserted in the inside of the glass run body 11, the vehicle-exterior seal lip 50 contacts as line-contact at its front end the side face of the door glass 5 and provides the sealing between the door glass 5 and the glass run 10E. Thus, the door glass 5 can smoothly move up and down. Further, since the vehicle-exterior seal lip 50 is provided on the surface with the low friction member as mentioned above, the door glass 5 can more smoothly move up and down.

The vehicle-exterior side wall 20 is similarly provided with the low friction member at the inside portion where the vehicle-interior extension lip 65 slides at its front end, and the low friction member 51 of the vehicle-exterior seal lip is formed. Therefore, the vehicle-exterior seal lip 50 slides smoothly. Since the vehicle-exterior seal lip 50 is smaller than the vehicle-interior seal lip 60, the door glass 5 is easily positioned outside of the vehicle within the glass run body 11.

The inside of the bottom wall 40 is formed with the low friction face 42 composed of the low friction member. The door glass 5 smoothly moves up and down while contacting at its front end the bottom low friction member 42 without causing abnormal noises. The bottom low friction member 42 is provided with a plurality of low friction grooves 43 formed in the lengthwise direction. With the bottom low friction grooves 43, dusts adhered to the bottom low friction member 42 can be discharged.

The bottom low friction member 42 is formed at the side end in the width direction with a projecting portion 44 along the vehicle-interior side wall 30 and the vehicle-exterior side wall 20. The bottom projecting portion 44 is flat at a contacting part of the vehicle-interior side wall 30 and the vehicle-exterior side wall 20, and when the glass run 10E is attached into the channel 3, the bottom projecting portion 44 contacts the vehicle-interior sidewall 30 and the vehicle-exterior side wall 20 respectively, supports, and prevent them from falling to the inside of the glass run body 11, so that the glass run body 11 can keep the U-shape in cross section.

The connections between the vehicle-exterior side wall 20 and the bottom wall 40 and between the vehicle-interior side wall 30 and the bottom wall 40 are respectively provided with vehicle-exterior side grooves 41, 41. By the vehicle-exterior side grooves 41, 41, the vehicle-exterior side wall 20 and the vehicle-interior side wall 30 can be flexibly bent with respect to the bottom wall 40, and the glass run 10E can be inserted in the channel 3 of the door frame 2.

In case the projecting portion 44 is provided to the bottom wall 40, when the door glass 5 is inserted in the glass run body 11, the vehicle-interior extension lip 65 contacts at its front end the boundary part between the bottom projecting portion 44 and the vehicle-interior side wall 30, that is, the bent portion between the vehicle-interior side wall 30 and the bottom wall 40, and therefore the bottom projecting portion 44 can steadily hold the front end of the vehicle interior extension lip 65. Thus, it is possible to more steadily compose the triangular false hollow part formed by the vehicle-interior seal lip 60, the vehicle-interior extension lip 65 and the vehicle-interior side wall 30, and prevent the false hollow part from being crushed in spite of the door glass 5 vibrating.

As mentioned above, the low friction face 61 of the vehicle-interior seal lip, the low friction face 51 of the vehicle-exterior seal lip and the low friction face 42 of the bottom wall are composed of the low friction members. The slow friction face 34 of the vehicle-interior side wall and the same 24 of the vehicle-exterior side wall are also composed of the low friction members.

In the embodiment shown in FIGS. 11 and 12, the low friction member is formed with the thermoplastic elastomer harder than the thermoplastic elastomer for forming the glass run body 11. The glass run body 11 is formed with the thermoplastic elastomer softer than the low friction member. In case this thermoplastic elastomer is an olefin based thermoplastic elastomer, for example, the harder thermoplastic elastomer may employ EPDM of the rubber content being 40% and polypropylene of the resin content being 60%, and in case the thermoplastic elastomer is the softer thermoplastic elastomer, for example, it may employ EPDM of the rubber content being 70% and polypropylene of the resin content being 30%.

By the way, in case the glass run body 11 is formed with the thermoplastic elastomer, the present invention displays effects in particular with the glass run made of the thermoplastic elastomer, because it is, as mentioned above, excellent in production and weight-reduction, though being slightly inferior to the rubber-made glass run body in fatigue property, but by making the false hollow part, this weak point may be overcome.

### Sixth Embodiment

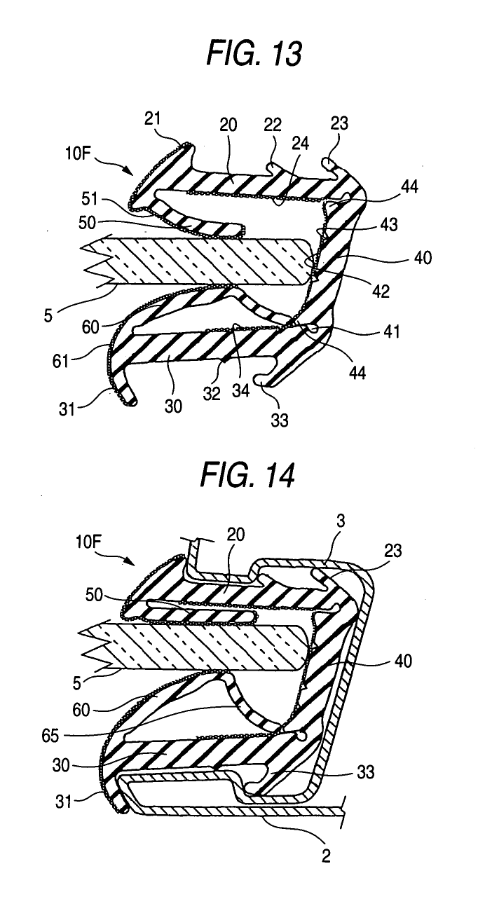

Next, on the basis of FIGS. 13 and 14, a sixth embodiment of the invention will be explained.

A glass run 10F of the sixth embodiment is the same as the third embodiment in the basic shape, but different in the composing materials. Explanation is omitted on the same parts as those of the fifth embodiment, and different parts will be referred to.

In the sixth embodiment, the glass run body 11, the vehicle-exterior seal lip 50 and the vehicle-interior seal lip 60 are composed of EPDM of the synthetic rubber. On the low friction face 61 of the vehicle-interior seal lip, the same 51 of the vehicle-exterior seal lip, the same 34 of the vehicle-interior side wall, and the same 24 of the vehicle-exterior side wall, a low friction material such as a low friction urethane paint is applied.

The bottom-low friction face 42 employs the coating of the urethane paint or flocks such as nylon short fabric. Then, the bottom wall 40 swells to form the bottom projecting portion 44 at both side ends in the width direction thereof for preventing the vehicle-exterior side wall 20 and the vehicle-interior side wall 30 from falling. The vehicle-interior extension lip 65 contacts at the front end bottom projecting portion 44, so that the almost triangular shape is formed by the vehicle-interior seal lip 60, the vehicle-interior extension lip 65 and the vehicle-interior side wall 30.

In addition, the low friction member may use other substances than the urethane paint as far as being low in frictional resistance, for example, TPO seat, non-woven fluorine resin, polyethylene seat, or silicone coat.

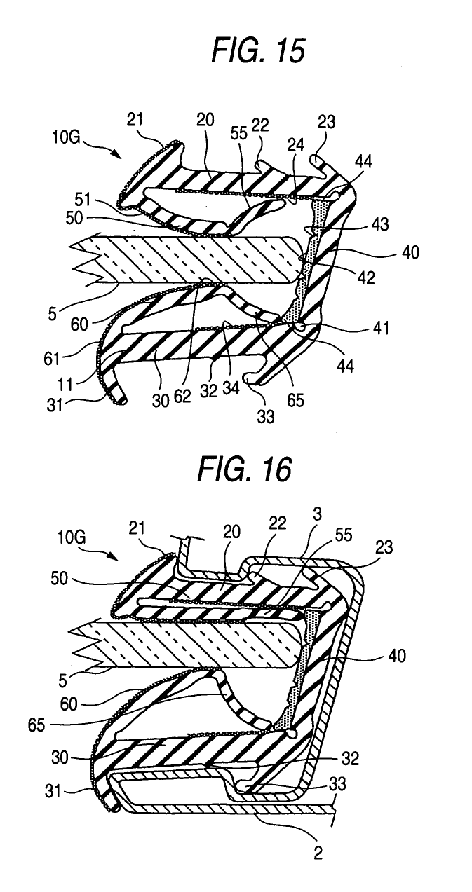

Explanation will be made to a seventh and eighth embodiments of the invention on the basis of FIGS. 15 to 18.

### Seventh Embodiment

On the basis of FIGS. 15 and 16, the seventh embodiment will be explained.

The basic structure of the glass run 10G is identical to the previous embodiments. The vehicle-exterior side lip 50 extends from the front end of the vehicle-exterior side wall 20 in the direction of the inside of the U-shape in cross section of the glass run body 11. At an inside joint part in relation with the vehicle-exterior side wall 20 of the vehicle-exterior seal lip 50, a thin part may be provided. With the thin part, the vehicle-exterior seal lip 50 is made easily bent. The vehicle-exterior seal lip 50 and the vehicle-exterior cover lip 21 are provided on the surfaces thereof continuously with the low slide members, and a low friction face 51 of the vehicle-exterior seal lip is formed. The low friction face 51 of the vehicle-exterior seal lip is harder than a material composing the glass run body 11.

The vehicle-exterior extension lip 55 extends from the front end of the vehicle-exterior seal lip 50. The vehicle-exterior extension lip 55 is bent from the front end of the vehicle-exterior seal lip 50 toward the vehicle-exterior side wall 20, and this bent part becomes a bent part 52 of the vehicle-exterior seal lip. The vehicle-exterior extension lip 55 is as a whole curved in a bow shape and formed as a convex toward the vehicle-exterior side wall 20. The length of the vehicle-exterior extension lip 55 is determined such that the vehicle-exterior extension lip 55 can contact the inside of the vehicle-exterior side all 30, even if the door glass 5 vibrates to the most vehicle-interior, when the door glass 5 enters at the end part into the inside of the glass run body 11. Thereby, when the door glass 5 is inserted in the glass run body 11, the triangular false hollow part can be assuredly formed by the vehicle-exterior seal lip 50, the vehicle-exterior extension lip 55 and the vehicle-exterior side wall 20.

By the way, preferably, the vehicle-exterior extension lip 55 has a length that the vehicle-exterior extension lip 55 contacts at the front end the boundary part between the bottom projection 44 and the inside of the vehicle-exterior side wall 20. Thereby, when the door glass 5 is displaced outside of the vehicle, the vehicle-exterior extension lip 55 is restrained in the front end moving, so that it is possible to hold the space between the vehicle-exterior side wall 20 as well as the vehicle-exterior seal lip 50 and the vehicle-exterior extension lip 55, and elastically hold the door glass 5 with the vehicle-exterior seal lip 50. Thus, vibration of the door glass 5 can be elastically and securely absorbed.

Since the vehicle-exterior extension lip 55 holds the front end of the vehicle-exterior seal lip 50, the peak of the triangle of the false hollow part, that is, the bent part 52 of the vehicle-exterior seal lip contacts as line-contacts the side face of the door glass 5, and can provide the sealing between the door glass 5 and the glass run 10G. Thus, the door glass 5 can smoothly move up and down. Further, since the vehicle-exterior seal lip 50 is provided on the surface with the low friction member as mentioned above, the door glass can more smoothly move up and down.

The vehicle-exterior side wall 20 is provided with the low friction member at the inside portion where the vehicle-exterior extension lip 55 slides at its front end. Therefore, the vehicle-exterior extension lip 55 can slide smoothly at its front end.

Since the thickness of the vehicle-exterior extension lip 55 is thinner than the vehicle-exterior seal lip 50, and is curved in convex in the direction of the vehicle-exterior side wall 20, even when the door glass 5 vibrates, the vehicle-exterior extension lip 55 can be easily bent and deformed to absorb vibration. Further, the triangular false hollow part can be assuredly formed by the vehicle-exterior seal lip 50, the vehicle-exterior extension lip 55 and the vehicle-exterior side wall 20, and therefore, this triangular false hollow part is elastically deformed, enabling to hold the door glass 5 and secure the predetermined force.

Since the vehicle-exterior seal lip 50 is smaller than the vehicle-interior seal lip 60, the door glass 5 is easily positioned outside of the vehicle in the inside of the glass run body 11.

The vehicle-interior seal lip 60 in this embodiment is identical to the fifth and sixth embodiments. Therefore, the explanation is omitted.

The inside of the bottom wall 40 is formed with the low friction face 42 composed of the low friction member. The door glass 5 smoothly moves up and down as contacting at its front end the low friction member 42 of the bottom wall without causing abnormal noises. The bottom low friction member 42 is provided with a plurality of low friction grooves 43 formed in the lengthwise direction. With the bottom low friction grooves 43, dusts adhered to the bottom low friction member 42 can be discharged.

The bottom low friction member 42 is formed at the side end in the width direction with a projecting portion 44 along the vehicle-interior side wall 30 and the vehicle-exterior side wall 20. The bottom projecting portion 44 is flat at a part of contacting the vehicle-interior side wall 30 to the vehicle-exterior side wall 20, and when the glass run 10G is attached into the channel 3, the bottom projecting portion 44 contacts the vehicle-interior side wall 30 and the vehicle-exterior side wall 20 respectively, supports, and prevent them from falling to the inside of the glass run body 11, so that the glass run body 11 can keep the U shape in cross section.

The connections between the vehicle-exterior side wall 20 and the bottom wall 40 and between the vehicle-interior side wall 30 and the bottom wall 40 are respectively provided with vehicle-exterior side grooves 41, 41. By the vehicle-exterior side grooves 41, 41, the vehicle-exterior side wall 20 and the vehicle-interior side wall 30 can be flexibly bent with respect to the bottom wall 40, and the glass run 10G can be inserted in the channel 3 of the door frame 2.

In case the bottom projecting portion 44 is provided to the bottom wall 40, when the door glass 5 is inserted in the glass run body 11, the vehicle-interior extension lip 65 contacts at its front end the boundary part between the bottom projecting portion 44 and the vehicle-interior side wall 30, that is, the bent portion between the vehicle-interior side wall 30 and the bottom wall 40, and therefore the bottom projecting portion 44 can securely hold the front end of the vehicle-interior extension lip 65. Thus, it is possible to more steadily compose the triangular false hollow part formed by the vehicle-interior seal lip 60, the vehicle-interior extension lip 65 and the vehicle-interior side wall 30, and prevent the false hollow part from being crushed in spite of the door glass 5 vibrating.

As mentioned above, the low friction face 61 of the vehicle-interior seal lip, the low friction face 51 of the vehicle-exterior seal lip and the low friction face 42 of the bottom wall are composed of the low friction members. The slow friction face 34 of the vehicle-interior side wall and the slow friction face 24 of the vehicle-exterior side wall are also composed of the low friction members.

The low friction member is formed with the thermoplastic elastomer harder than the thermoplastic elastomer for forming the glass run body 11. The glass run body 11 is formed with the thermoplastic elastomer softer than the low friction member. In case this thermoplastic elastomer is an olefin based thermoplastic elastomer, for example, the harder thermoplastic elastomer may employ EPDM of the rubber content being 40% and polypropylene of the resin content being 60%, and in case the thermoplastic elastomer is the softer thermoplastic elastomer, for example, it may employ EPDM of the rubber content being 70% and polypropylene of the resin content being 30%.

By the way, in case the glass run body 11 is formed with the thermoplastic elastomer, the present invention displays effects in particular with the glass run made of the thermoplastic elastomer, because it is, as mentioned above, excellent in production and weight-reduction, though being slightly inferior to the rubber-made glass run body in fatigue property, but by making the false hollow part, this weak point may be overcome.

### Eighth Embodiment

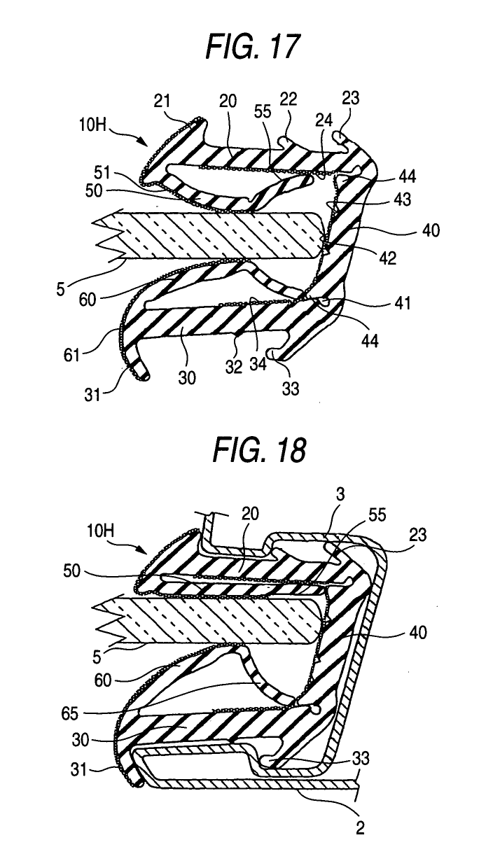

Next, on the basis of FIGS. 17 and 18, the eighth embodiment will be explained.

A glass run 10H of the eighth embodiment is the same as the seventh embodiment in the basic shape, but different in the composing materials. Explanation is omitted on the same parts as those of the eighth embodiment, and different parts will be referred to.

In the eighth embodiment, the glass run body 11, the vehicle-exterior seal lip 50 and the vehicle-interior seal lip 60 are composed of EPDM of the synthetic rubber. The low friction face 61 of the vehicle-interior seal lip, the same 51 of the vehicle-exterior seal lip, the same 34 of the vehicle-interior side wall, and the same 24 of the vehicle-exterior side wall are coated with, for example, low friction urethane paint.

The bottom-low friction face 42 employs the coating of the urethane paint or flocks such as nylon short fabric. Then, the bottom wall 40 swells to form the bottom projecting portion 44 at both side ends in the width direction thereof for preventing the vehicle-exterior side wall 20 and the vehicle-interior side wall 30 from falling. The vehicle-interior extension lip 65 contacts at the front end bottom projecting portion 44, so that the almost triangular shape is formed by the vehicle-interior seal lip 60, the vehicle-interior extension lip 65 and the vehicle-interior side wall 30.

1. A glass run which is mounted in a door frame of a vehicle door to guide a door glass, comprising:
a glass run body having a U-shape in cross section including an exterior side wall having an exterior seal lip, an interior side wall having an interior seal lip and a bottom wall connecting said exterior side wall and said interior side wall,
each of said exterior seal lip and said interior seal lip extending toward an inner part of the U-shape of said glass run body in which said door glass is inserted, so that said exterior seal lip and said interior seal lip provide a sealing between an exterior surface and an interior surface of said door glass respectively, wherein said interior seal lip is formed longer than
said exterior seal lip, and includes an interior seal lip body extending from said interior side wall, a bent portion at a front end portion of said interior seal lip body, and a front end part of said interior seal lip extending from said bent portion,
said front end portion is configured to contact with a contact face that is formed on an inner surface of said interior side wall facing to the inner part of the U-shape, when said door glass is inserted in the inner part of the U-shape,
wherein said contact face is provided with a low-frictional member so that said front end portion of said interior seal lip easily moves on said wall surface.

2. The glass run according to claim 1, wherein said contact face is a flat face from a part continuing with said bottom wall of said interior side wall to a substantially central portion on said inner surface of said interior side wall.

3. The glass run according to claim 1, wherein said contact face is a slant face which is formed between a projection in a vicinity of a central portion on said inner surface of said interior side wall and a part continuing with said bottom wall.

4. The glass run according to claim 1, wherein said contact face is a curved face which has a convex toward an interior side of the vehicle between a vicinity of central portion of said inner part of said interior side wall and a part continuing part with said bottom wall.

5. The glass run according to claim 1, wherein said front end portion of said interior seal lip has a length so as to be bendable when said front end portion contacts and slides on said contact face.

6. A glass run which is mounted in a door frame of a vehicle door to guide a door glass, comprising:
a glass run body having a U-shape in cross section including an exterior side wall having an exterior seal lip, an interior side wall having an interior seal lip and a bottom wall connecting said exterior side wall and said interior side wall;
each of said exterior seal lip and said interior seal lip extending toward an inner part of the U-shape of said glass run body in which said door glass is inserted, so that said exterior seal lip and said interior seal lip provide a sealing between an exterior surface and an interior surface of said door glass respectively,
wherein said interior seal lip is formed longer than said exterior seal lip, and includes a root portion of extending from said interior side wall and a front end portion of said interior seal lip connected to said root portion through a bent portion,
a thickness of said root portion is larger than a thickness of said front end portion, connection between said root portion and said front end portion is made a bent portion of said interior seal lip forming a bent point, a variation in thickness of said bent portion is made larger anther part in said interior seal lip.

7. The glass run according to claim 6, wherein said root portion of said interior seal lip has substantially a constant thickness so as to be flat, and said front end portion of said interior seal lip becomes gradually thinner toward the front end.

8. The glass run according to claim 6, wherein an inner surface of said root portion is concavely curved so that a central portion of said root portion is formed to be thinner than both ends thereof and to be thicker than said front end portion, and
an inner surface of said front end portion is concavely curved.

9. A glass run which is mounted in a door frame of a vehicle door to guide a door glass, comprising:
a glass run body having a U-shape in cross section including an exterior side wall having an exterior seal lip, an interior side wall having an interior seal lip and a bottom wall connecting said exterior side wall and said interior side wall;
each of said exterior seal lip and said interior seal lip extending toward an inner part of the U-shape of said glass run body in which said door glass is inserted, so that said exterior seal lip and said interior seal lip provide a sealing between an exterior surface and an interior surface of said door glass respectively,
wherein an interior extension lip is extended from a front end of said interior seal lip toward said interior side wall,
said interior extension lip is curved in convex toward said interior side wall.

10. A glass run according to claim 9, wherein when said door glass is inserted in said glass run body, said interior extension lip contacts with said bottom wall at a front end thereof.

11. The glass run according to claim 10, wherein a projection projecting along said interior side wall is formed on an inner surface of said bottom wall at a side end part thereof,
when said door glass is inserted in said glass run body, a front end of said interior extension lip contacts with a boundary part between said bottom projection and an inner surface of said interior side wall.

12. The glass run according to claim 9, wherein a thickness of said interior extension lip is thinner than said interior seal lip.

13. The glass run according to claim 10, wherein said glass run body, said interior seal lip, and said exterior seal lip are formed with a thermoplastic elastomer, and low friction members on said interior seal lip, on said surface of said exterior seal lip and on the inner surface of said bottom wall are formed with a thermoplastic elastomer having a higher hardness than a hardness of said thermoplastic elastomer of said glass run body.

14. A glass run which is mounted in a door frame of a vehicle door to guide a door glass, comprising:
a glass run body having a U-shape in cross section including an exterior side wall having an exterior seal lip, an interior side wall having an interior seal lip and a bottom wall connecting said exterior side wall and said interior side wall;
each of said exterior seal lip and said interior seal lip extending toward an inner part of the U-shape of said glass run body in which said door glass is inserted, so that said exterior seal lip and said interior seal lip provide a sealing between an exterior surface and an interior surface of said door glass respectively,
wherein an exterior extension lip is extended from a front end of said exterior seal lip toward said exterior side wall, and an interior extension lip is extended from a front end of said interior seal lip toward said interior side wall, and
said interior extension lip and said exterior extension lip are curved in convex toward said interior side wall and said exterior side wall.

15. The glass run according to claim 14, wherein a bottom projection projecting along said interior side wall is formed on an inner surface of said bottom wall at a side end part thereof,
when said door glass is inserted in said glass run body, a front end of said exterior extension lip contacts with an inner surface of said exterior side wall and a front end of said interior extension lip contacts with a boundary part between said bottom projection and an inner surface of said interior side wall.

16. The glass run according to claim 14, wherein a bottom projection projecting along said exterior side wall is formed on an inner surface of said bottom wall at a side end part thereof,
when said door glass inserted in said glass run body is displaced to an interior side of said vehicle, a front end of said exterior extension lip contacts with an inner surface of said exterior side wall, and
when said door glass is displaced to an exterior side of said vehicle, a front end of said exterior extension lip contacts with a boundary part between said bottom projection and an inner surface of said exterior side wall.

17. The glass run according to claim 14, wherein surfaces of said interior seal lip and of said exterior seal lip, and the inner surface of said bottom wall are provided with low friction members.

18. The glass run according to claim 14, wherein said exterior extension lip and said interior extension lip are respectively smaller in thickness than said exterior seal lip and said interior seal lip.

19. The glass run according to claim 14, wherein said glass run body, said interior seal lip and said exterior seal lip are formed with thermoplastic elastomer, while said low friction members of the surfaces of said interior seal lip and of said exterior seal lip and said low friction member of the inner surface of said bottom wall are formed with a thermoplastic elastomer having a higher hardness than a hardness of said thermoplastic elastomer of said glass run body.

20. The glass run according to claim 14, wherein said low friction members are provided at parts where the exterior extension lip and the interior extension lip of the insides of the exterior side wall and the interior side wall respectively contact.
